(19) United States
(12) Patent Application Publication
(10) Pub. No.: US 2013/0180316 A1
(43) Pub. Date: Jul. 18, 2013

(54) RESONANT KNOCK SENSOR

(71) Applicants: I-MIN LIN, Changhua County (TW); Ching-Tsan Lin, Changhua County (TW); You-Chong Li, Changhua County (TW)

(72) Inventors: I-MIN LIN, Changhua County (TW); Ching-Tsan Lin, Changhua County (TW); You-Chong Li, Changhua County (TW)

(21) Appl. No.: 13/441,443

(22) Filed: Apr. 6, 2012

(30) Foreign Application Priority Data
Jan. 13, 2012 (TW) 101101368

(51) Int. Cl. G01L 23/22

(52) U.S. Cl. 73/35.11

(57) ABSTRACT

A resonant knock sensor includes a housing, a pedestal and a vibration diaphragm. The housing is provided with a support surface therein. The pedestal is fixed in the housing and has a base with a bottom surface attached to the support surface, a support portion protruding from a top surface of the base, and a vibration piece connected to an end of the support portion. The vibration diaphragm is mounted on the vibration piece. As a result, pedestals with different geometric sizes in their support portions or vibration pieces can be selectively assembled with single sized housings and vibration diaphragms to fabricate sensors with different frequency sensibilities at a low manufacturing cost.

### BACKGROUND OF THE INVENTION

1. Field of the Invention

The present invention relates generally to knock sensors and more particularly, to a resonant knock sensor.

2. Description of the Related Art

The conventional resonant knock sensor comprises a base and a vibration diaphragm made from piezoelectric material. The base is integrally formed with a housing, a pillar located in the housing and a vibration piece located on the top of the pillar. The vibration diaphragm is attached on the vibration piece.

The resonant knock sensor is mounted to a car engine by means of fixing the base to the car engine. When a knock occurs in the engine to resonate the vibration piece and the vibration diaphragm, the vibration diaphragm will output a voltage signal in response to the knock to the engine control module of the car, such that the engine control module will take measures, such as retarding spark timing, to control the knock.

Aforesaid resonant knock sensors applied to engines with different specifications should have bases with different shapes or sizes to make the resonance frequency of the vibration diaphragms match the knock frequency of the engines. Which means the manufacturer would have to make different bases for engines with different specifications in order to provide the knock sensors with different frequency sensibilities. This results in increase of the manufacturing cost of the conventional resonant knock sensor. Therefore, the conventional resonant knock sensor needs to be improved.

### SUMMARY OF THE INVENTION

The present invention has been accomplished in view of the above-noted circumstances. It is an objective of the present invention to provide a resonant knock sensor having a replaceable resonant part, such that resonance frequency of the sensor can be tuned at a low cost.

To attain the above objective, the present invention provides a resonant knock sensor which comprises a housing, a pedestal and a vibration diaphragm. The housing is provided at an inside thereof with a support surface. The pedestal is fixed in the housing and has a base with a bottom surface attached to the support surface of the housing, a support portion protruding from a top surface of the base, and a vibration piece connected to an end of the support portion. The vibration diaphragm is mounted on the vibration piece of the pedestal.

When the resonant knock sensor is in use, the housing is fixed to an object to be detected, such as a car engine, and the vibration diaphragm will output a voltage signal in response to the vibration of the object under detection. The pedestal is not integrally formed with the housing. As a result, the manufacturer can use single sized housings and single sized vibration diaphragms in cooperation with pedestals having various geometric sizes in cross-section area or length of the support portion and/or in thickness of the vibration piece to fabricate sensors with different frequency sensibilities at a low cost.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an assembled perspective view of a resonant knock sensor provided by a first preferred embodiment of the present invention;

FIG. 2 is an exploded perspective view of the resonant knock sensor provided by the first preferred embodiment of the present invention;

FIG. 3 and FIG. 4 are sectional views of the resonant knock sensor provided by the first preferred embodiment of the present invention;

FIG. 5 is a sectional view of a resonant knock sensor provided by a second preferred embodiment of the present invention; and

FIG. 6 is a sectional view of a resonant knock sensor provided by a third preferred embodiment of the present invention.

### DETAILED DESCRIPTION OF THE INVENTION

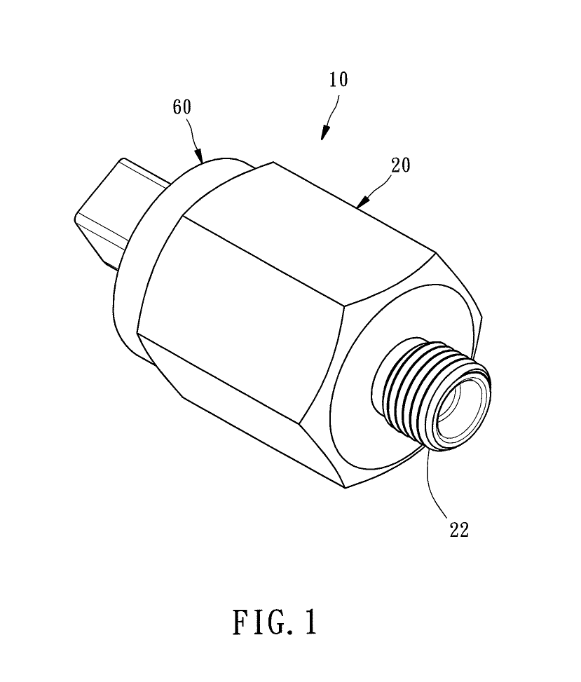

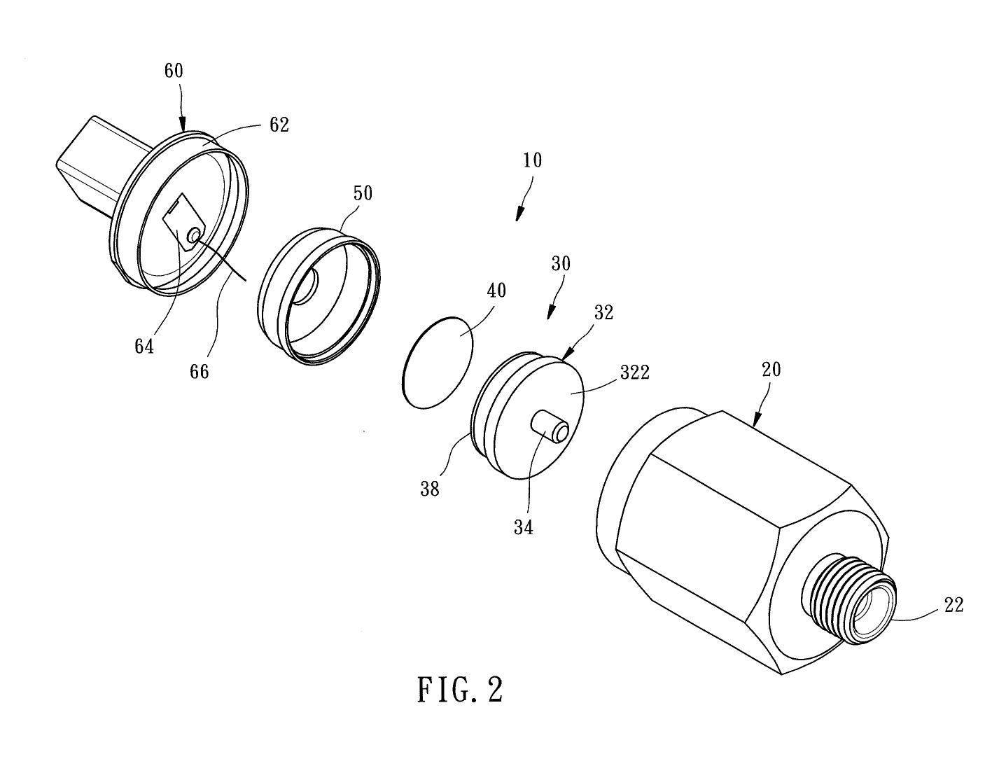

As shown in FIG. 1 and FIG. 2, a resonant knock sensor 10, which is provided by a first preferred embodiment of the present invention, comprises a housing 20, a pedestal 30, a vibration diaphragm 40, a protection cap 50 and a transmitter 60.

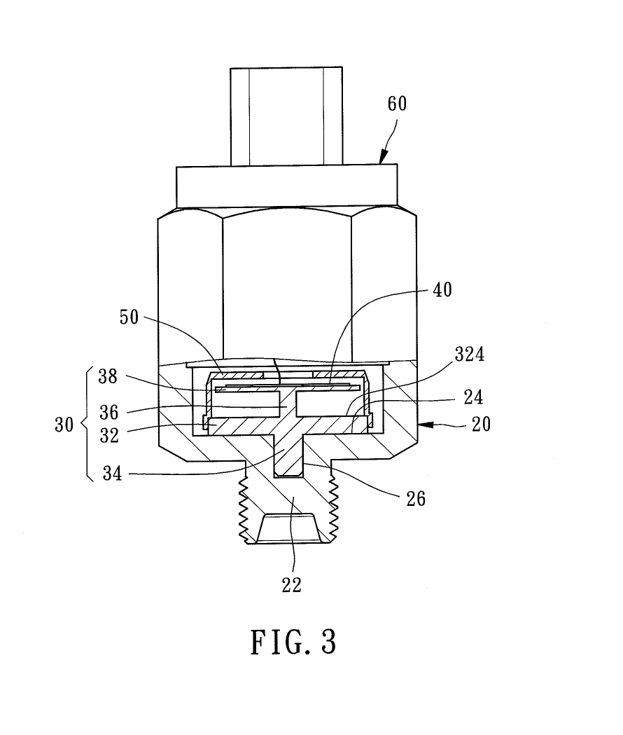

The housing 20 is made from high-hardness metal, such as iron, and has an outer connection portion 22. As shown in FIG. 3, the housing 20 is provided at an inside thereof with a support surface 24 and an inner connection portion 26 located at the support surface 24.

The pedestal 30 is made from low-hardness and easy-to-cut metal, such as copper alloy, and has a base 32, a mounting portion 34 located at a bottom surface 322 of the base 32, a support portion 36 protruding from a top surface 324 of the base 32, and a vibration piece 38 connected to an end of the support portion 36. The mounting portion 34 is fixed to the inner connection portion 26 of the housing 20. The bottom surface 322 of the base 32 is abutted against the support surface 24 of the housing 20.

In this embodiment, the inner connection portion 26 of the housing 20 is a hole concaved from the support surface 24, and the mounting portion 34 of the pedestal 30 is a pillar protruding from the bottom surface 322 of the base 32. The mounting portion 34 is inserted into the inner connection portion 26 and fixed by adhesive. However, the way that the inner connection portion 26 is connected with the mounting portion 34 is not limited to it. For example, the inner connection portion 26 and the mounting portion 34 can also be a pillar and a hole respectively.

The vibration diaphragm 40, which is made from piezoelectric material, is mounted on the vibration piece 38 of the pedestal 30 by adhesive. Therefore, the vibration diaphragm 40 can output a voltage signal in response to the vibration of the housing 20.

The protection cap 50 is mounted to the base 32 of the pedestal 30 and covers the vibration diaphragm 40 for protecting the vibration diaphragm 40. However, the sensor 10 can also be configured without the protection cap 50.

The transmitter 60 has a main body 62 made from plastic, and an electrically conductive portion 64 made from metal and fixed in the main body 62. The main body 62 is riveted to the housing 20. The electrically conductive portion 64 is connected with the vibration diaphragm 40 by a conducting wire 66.

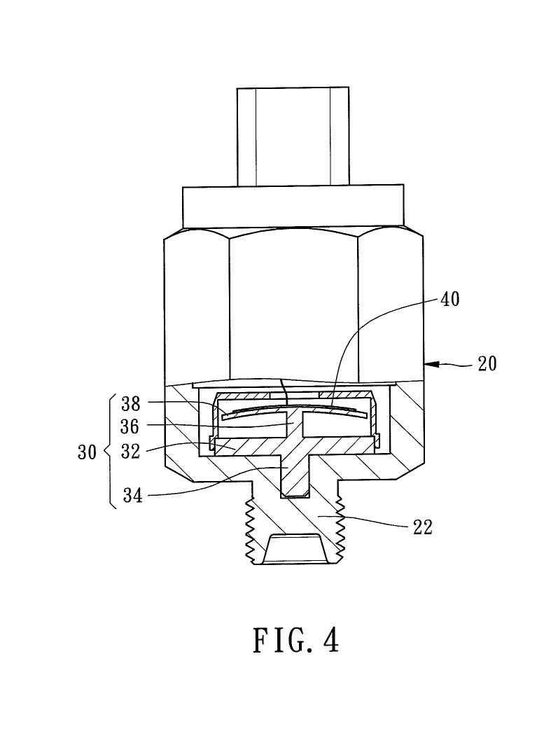

When the resonant knock sensor 10 is in use, the outer connection portion 22 of the housing 20 is fixed to an object to be detected (not shown), such as a car engine, and the transmitter 60 is connected with a transmitting wire (not shown) for transmitting the voltage signal output by the vibration diaphragm 40 to an engine control module (not shown). As long as the knock frequency of the object under detection matches the resonance frequency of the vibration piece 38 and the vibration diaphragm 40, when a knock occurs in the object, the vibration diaphragm 40 will be resonated (as shown in FIG. 4) and output a voltage signal having an intense peak in response to the knock to the engine control module, such that the engine control module will take measures for controlling the knock.

In this embodiment, the mounting portion 34 and the support portion 36 of the pedestal 30 are cylinders, and the outer connection portion 22 of the housing 20 is a cylinder with external threads. The mounting portion 34, the support portion 36 and the outer connection portion 22 are coaxially aligned to each other so that the frequency sensed by the combination of the vibration piece 38 and the vibration diaphragm 40 is about the same with the real vibration frequency of the object under detection. However, the shapes of the mounting portion 34, the support portion 36 and the outer connection portion 22 are not limited under the condition that their locations are aligned to each other.

If the pedestal 30 of the resonant knock sensor 10 is replaced by another pedestal 30 with different geometric size, e.g. sectional area or length, in the support portion 36, or different geometric size, e.g. thickness, in the vibration piece 38, the resonance frequency of the vibration piece 38 and the vibration diaphragm 40 will change accordingly. Therefore, the manufacturer only has to make different scales of pedestals 30 for fabricating sensors 10 with different frequency sensibilities. Which means the resonant knock sensors 10 having different resonant frequencies for detecting different knock frequencies can adopt the same housings 20, protection caps 50 and transmitters 60 so as to lower the manufacturing costs of the sensors 10.

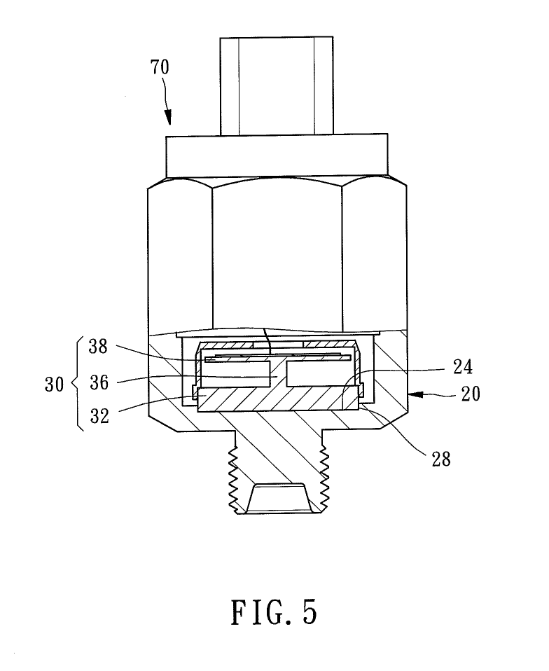

FIG. 5 shows a resonant knock sensor 70 provided by a second preferred embodiment of the present invention. As shown in FIG. 5 and FIGS. 1-4, the difference between the resonant knock sensor 70 and the sensor 10 disclosed in FIGS. 1-4 lies in that the housing 20 of the sensor 70 is provided at an inside thereof with a recess 28, the support surface 24 is defined in the recess 28, and the pedestal 30 of the sensor 70, which is provided with no such a mounting portion 34, has its base 32 fixed in the recess 28. As a result, the sensor 70 has not only the same capability with the sensor 10 but also an advantage of simple construction that can be made easily.

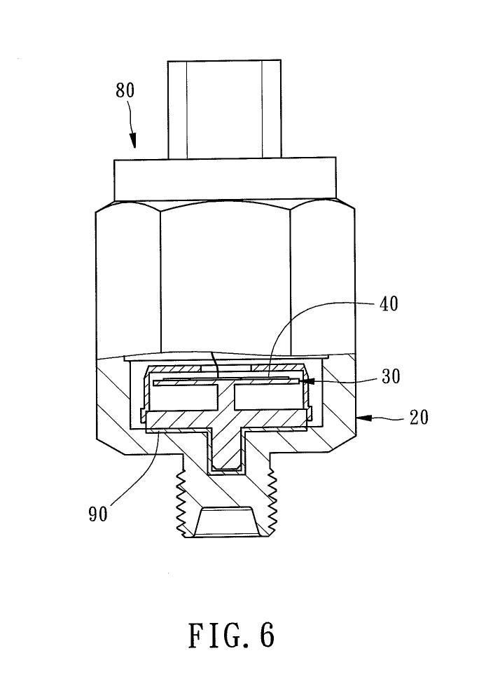

FIG. 6 shows a resonant knock sensor 80 provided by a third preferred embodiment of the present invention. As shown in FIG. 6, the difference between the resonant knock sensor 80 and the sensor 10 defined in FIGS. 1-4 lies in that the sensor 80 further comprises an insulator 90 attached between the housing 20 and the pedestal 30 to prevent the voltage signal output by the vibration diaphragm 40 from electromagnetic interference. The sensor 70 provided by aforesaid second preferred embodiment can also be equipped with an insulator attached between the housing 20 and the pedestal 30.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A resonant knock sensor comprising:
a housing provided at an inside thereof with a support surface;
a pedestal fixed in the housing and having a base with a bottom surface attached to the support surface of the housing, a support portion protruding from a top surface of the base, and a vibration piece connected to an end of the support portion; and
a vibration diaphragm mounted on the vibration piece of the pedestal.

2. The resonant knock sensor as claimed in claim 1, wherein the housing has an inner connection portion located at the support surface; the pedestal has a mounting portion located at the bottom surface of the base and corresponding in location to the support portion; the mounting portion of the pedestal is fixed to the inner connection portion of the housing.

3. The resonant knock sensor as claimed in claim 2, wherein the inner connection portion of the housing is a hole concaved from the support surface; the mounting portion of the pedestal is a pillar protruding from the bottom surface of the base and inserted into the inner connection portion of the housing.

4. The resonant knock sensor as claimed in claim 3, wherein the mounting portion and the support portion of the pedestal are cylinders coaxially aligned to each other.

5. The resonant knock sensor as claimed in claim 4, wherein the housing has an outer connection portion coaxially aligned to the mounting portion and the support portion of the pedestal.

6. The resonant knock sensor as claimed in claim 2, wherein the housing has an outer connection portion corresponding in location to the mounting portion and the support portion of the pedestal.

7. The resonant knock sensor as claimed in claim 1, further comprises a protection cap mounted to the pedestal and covering the vibration diaphragm.

8. The resonant knock sensor as claimed in claim 1, further comprises a transmitter mounted to the housing and having an electrically conductive portion electrically connected with the vibration diaphragm for transmitting a voltage signal output by the vibration diaphragm.

9. The resonant knock sensor as claimed in claim 1, wherein the housing is provided with a recess and the support surface is located in the recess.

10. The resonant knock sensor as claimed in claim 1, further comprises an insulator attached between the housing and the pedestal.
